(19) United States
(12) Patent Application Publication
(10) Pub. No.: US 2021/0245731 A1
(43) Pub. Date: Aug. 12, 2021

(54) Method for Controlling at Least One Motor Vehicle Function and Control System

(71) Applicant: U-Shin Deutschland Zugangssysteme GmbH, Erdweg (DE)

(72) Inventor: Marc-Tell Lammich, Erdweg (DE)

(73) Assignee: U-Shin Deutschland Zugangssysteme GmbH, Erdweg (DE)

(21) Appl. No.: 17/151,752

(22) Filed: Jan. 19, 2021

(30) Foreign Application Priority Data
Feb. 6, 2020 (DE) 102020103083.5

(51) Int. Cl. B60W 30/00; B60W 10/30; B60W 10/08; B60W 10/06; B60W 10/18; B60W 10/20; B60W 60/00; B60W 40/08

(52) U.S. Cl. CPC B60W 30/00; B60W 10/30; B60W 10/08; B60W 10/06; B60W 2040/0809; B60W 10/20; B60W 60/00; B60W 40/08; B60W 2556/55; B60W 10/18

(57) ABSTRACT

The invention relates to a method of controlling at least one motor vehicle function of a motor vehicle, wherein the method comprises at least the step of position detection of a mobile terminal, such as a cell phone or a key, by radio according to a first and second radio standard, wherein the first and second radio standard are different, the step of verification of a detected position of the mobile terminal by comparison of the position detection by radio according to the first radio standard with the position detection by radio according to the second radio standard and the step to control at least one motor vehicle function, if the verified position of the mobile terminal is in the motor vehicle interior. Furthermore, the invention relates to a control system to control a motor vehicle function of a motor vehicle.

### CROSS-REFERENCE TO RELATED APPLICATIONS

This application claims priority to German Application Serial No. 102020103083.5, filed Feb. 6, 2020, the content of which is incorporated herein by reference in its entirety.

### TECHNICAL FIELD

The present invention relates to a method for controlling a motor vehicle function of a motor vehicle as well as a control system for controlling at least one motor vehicle function.

### BACKGROUND

Modern motor vehicles have a number of motor vehicle functions. These motor vehicle functions can mostly be controlled by means of input from the user, usually the driver. In some cases, it may be advantageous to have motor vehicle functions that need to be controlled on a regular basis and/or actively controlled by a control system. This eliminates the need for input by the user to control some motor vehicle functions, and the user is relieved by the control system. One motor vehicle function that requires frequent control is, for example, switching the drive engine on or off. Such control of the drive engine may, for example, be performed by the control system. The control system can control the drive engine depending on the position of a mobile terminal, such as a key element. Thus, for convenient use by the driver, the drive engine may be initiated by the control system if the user is inside the motor vehicle with the mobile terminal. The position of the mobile terminal is usually detected by radio.

A position detection of the mobile terminal via radio, for example using Bluetooth, may be inaccurate. Consequently, a position of the mobile terminal detected by radio may be within the motor vehicle, even though the actual position of the mobile terminal is not within the motor vehicle. For example, automatic control of the drive engine, such as switching it on, by means of the control system may possibly lead to undesirable situations in such a situation, since the user, preferably the driver, may then not be inside the motor vehicle.

### DESCRIPTION OF THE INVENTION

The object of the present invention is to improve a method and a control system for controlling a motor vehicle function.

This task is solved by the objects of the independent patent claims. Advantageous embodiments with expedient further developments of the invention are indicated in the respective dependent claims.

A first aspect of the invention relates to a method for controlling at least one motor vehicle function of a motor vehicle. A motor vehicle may, for example, be a passenger car or a truck. The method comprises a step of at least one position detection of a mobile terminal. The mobile terminal may, for example, be a cell phone, a key or key element, in particular a key of the motor vehicle, a tablet, a laptop, a wearable, such as a watch, in particular a smartwatch, a pair of glasses, preferably data glasses, an implant or a garment with integrated electronic means. For example, the mobile terminal may comprise a control unit, such as a microchip, a power supply unit, such as a battery, and/or a communication unit, such as an RFID chip and/or a Bluetooth, WLAN and/or UWB transceiver.

The position detection is performed by radio according to a first and a second radio standard. The two radio standards are different. Thus, the two radio standards may differ at least in the frequency band or frequency range used, the modulation type used, transmission rate, range, security standard, stability and/or power density. Position detection refers to a detection of the position of the mobile terminal in space relative to the motor vehicle. A detected position can be represented in the form of a three-dimensional vector with respect to a space zero point. The space zero point can, for example, be fixed to the vehicle and, in particular, be located centrally in the interior. The position can be represented over a distance and at least one angle with respect to a defined space zero point and defined space axes of the motor vehicle. If there is only one angle, it can be assumed for the position, for example, that it is in a horizontal plane with the motor vehicle. The position detection determines a detected position of the mobile terminal. A detected position may be an approximation of the actual spatial position of the terminal device.

A position detection by radio according to the first radio standard can be performed by means of triangulation of several determined distances between the mobile terminal and radio devices of the motor vehicle. Triangulation can use three or more distance measurements for position detection, for example by means of antennas spaced apart from each other. Thus, position detection of the mobile terminal may be performed at least in the entire motor vehicle interior. The motor vehicle interior is the space which is delimited from the outermost boundaries of the motor vehicle against an external space. The external space may, for example, be a vehicle environment. The motor vehicle interior may, for example, be or at least comprise a passenger compartment. In addition, a position detection by radio according to the first radio standard can be performed at least in an adjacent motor vehicle exterior, which extends proximately around the motor vehicle interior.

A position detection by radio according to the second radio standard can be performed similarly to the position detection by radio according to the first radio standard, for example by means of triangulation. Position detection by radio according to the second radio standard can also be performed by means of short-range position detection, preferably by means of one antenna and thereby, for example, without using triangulation. Short-range position detection by radio according to the second radio standard may be limited in range by the confines of the motor vehicle interior. Short-range position detection by radio according to the second radio standard may provide position detection within a shorter range than position detection by radio according to the first radio standard. For example, short-range position detection may determine the position of the mobile terminal by merely receiving a radio signal according to the second radio standard, in which case the mobile terminal is located within a minimum distance to a receiver. Thus, a position of the mobile terminal may be detected if the mobile terminal is in close proximity to one of one or more radio devices present. For example, the radio device may comprise respective antennas for transmitting and/or receiving respective radio signals according to the second radio standard. Close proximity may be, for example, a few centimeters. Advantageously, such a position detection is thereby comparatively accurate, in particular compared to detection according to the first radio standard.

Preferably, position detection by radio according to the first radio standard may have a longer range than position detection by radio according to the second radio standard. Preferably, the position detection by radio according to the first radio standard may be more energy-saving than the position detection by radio according to the second radio standard. Preferably, the position detection by radio according to the second radio standard may be more accurate than the position detection by radio according to the first radio standard.

For example, position detection by radio according to the first and second radio standard may be performed substantially simultaneously. This allows the position detection to be performed in a time-saving manner and/or the detected position to be verified. Advantageously, the position detection by radio according to the first radio standard can take place before the position detection by radio according to the second radio standard, meaning that initially only the position according to the first radio standard can be detected. In this case, the position detection by radio according to the second radio standard can only be activated once the position detection by radio according to the first radio standard has determined a detected position that is located in the vehicle interior. Advantageously, the position detection by radio according to the second radio standard can only be activated if the position detection by radio according to the first radio standard has determined a detected position that is located in a specific section of the motor vehicle interior, such as an area of a center console or a dashboard. Thus, advantageously, the position detection can be performed in an energy-saving manner, since the position detection by radio according to the second radio standard is not performed if the position detection by radio according to the first radio standard does not result in a detected position of the mobile terminal in the motor vehicle interior. The verification of the position can then take place after the activation of the position detection according to the second radio standard, wherein the position detection according to the first and the second radio standard then can be performed substantially simultaneously.

The method for controlling at least one motor vehicle function further comprises at least a verification of the detected position of the mobile terminal. The verification is performed by comparing the position detections by radio according to the first radio standard and according to the second radio standard. As a result, the comparison may determine a match of the positions of the mobile terminal detected by the two position detections. The matching may mean an exact matching of the detected positions in space. The matching may mean an approximate matching of the detected positions in space. The approximate match may mean a match of the detected positions within a predeterminable threshold value. The threshold value may be set so that it takes into account the measurement inaccuracy of both position detections. Measurement inaccuracies may, for example, correspond to respective maximum measurement tolerances of the position detection of the respective radio standard. If the positions of the mobile terminal detected by the two position detections do not match, the detected position of the mobile terminal is not verified. The result of the comparison in this case may be that the detected position could not be verified. If the verification of the detected position is successful, the verified position may be assumed, for example, to be the detected position that was detected by radio according to the most position-accurate radio standard. In general, the verified position may also be the entire motor vehicle interior. As a result of the comparison, the verified position may also be outside the motor vehicle interior. This is the case, for example, if the position detected according to the first radio standard is outside the motor vehicle interior and the position detected according to the second radio standard is also outside the motor vehicle interior.

The method for controlling at least one motor vehicle function further comprises at least one step of controlling the motor vehicle function if the verified position of the mobile terminal is in the motor vehicle interior. The controlling of the motor vehicle function may be performed temporally directly after the verification of the position of the mobile terminal in the motor vehicle interior. Alternatively, or additionally, the control of the motor vehicle function may occur with an adjustable temporal offset after the verification of the position of the mobile terminal in the motor vehicle interior. The temporal offset may be set by a user or may be fixed. The temporal offset may also be specific to the motor vehicle function to be controlled. For example, the controlling comprises at least starting the motor vehicle function. For example, the controlling comprises monitoring the motor vehicle function after starting and monitoring the motor vehicle function while executing the motor vehicle function. The controlling may also be a stopping of the motor vehicle function. If the position could not be verified or the verified position is outside the interior of the motor vehicle, for example, no controlling of the motor vehicle function can be performed or the motor vehicle function can be controlled differently. If the position could not be verified or the verified position is outside the interior of the motor vehicle, the motor vehicle function is, for example, not started or the motor vehicle function, for example, continues to be executed without any changes.

For example, the control of the motor vehicle function can be user-specific. In one exemplary embodiment, the method can uniquely assign to each user a mobile terminal or to each user a mobile terminal can be uniquely assigned. A parameter set may be assigned to each user, wherein the motor vehicle function may be controlled depending on the parameter set. This can be done, for example, by means of a centralized and/or decentralized database, which is queried using the method. A central database can, for example, be a database of the motor vehicle manufacturer, which can be queried by radio from the motor vehicle. A decentralized database can be, for example, a preconfigurable database of the motor vehicle. During initial startup, for example, a user list with uniquely assigned mobile terminals can be stored in the database. For example, alternatively or additionally, the motor vehicle function to be controlled can be different for different mobile terminals.

Advantageously, the method ensures that the motor vehicle function is controlled when the verified position of the mobile terminal is in the motor vehicle interior. Advantageously, the driver carries the mobile terminal with him and thus indirectly proves that he is in the motor vehicle interior if the mobile terminal is in the motor vehicle interior. This increases the application safety of the controlled motor vehicle function, since the control of the motor vehicle function does not occur or occurs differently if the driver is outside the motor vehicle interior with his mobile terminal. Thus, the driver can, if necessary, intervene at any time during the control of the motor vehicle function, which can be executed automatically.

The method can also be used to control two or more motor vehicle functions if the verified position of the mobile terminal is inside the motor vehicle interior. In the following, some examples of motor vehicle functions are given, which are advantageously controlled by the method. The method may also control only one of these functions, several or all of them depending on the verification that the position of the mobile terminal is in the motor vehicle interior.

In another exemplary embodiment, the motor vehicle function may be, for example, a motor function, such as switching a drive engine on or off. Advantageously, a drive engine may be turned on and/or an ignition may be enabled when a user having a mobile terminal enters the vehicle. The drive engine may be, for example, an internal combustion engine or an electric motor. Further engine functions which can be controlled by the method are, for example, performance functions, such as an adjustment of a mixture injection, a mixture composition or a maximum torque, such as a maximum torque of an electric motor. Advantageously, the engine function can be controlled in an individually adapted manner if a specific user with a specific mobile terminal is in the motor vehicle interior.

For example, the motor vehicle function may be a heating function, such as heating of a motor vehicle interior, of a battery, or of the drive engine. The heating of the motor vehicle interior may comprise, for example, heating the ambient air, one or more seats, or heating the steering wheel. Controlling the heating may be dependent on the user associated with the mobile terminal. Advantageously, for example, a steering wheel may be heated to a different temperature for different users who have different mobile terminals. Advantageously, heating the battery can improve the efficiency of a battery-powered electric vehicle. This heating can comprise a preheating of the battery before driving off. Heating the battery can be started directly when the user, who has a mobile terminal, enters the vehicle, thus making the best use of the stored energy of the battery, especially when driving off promptly. The heating may comprise a preheating of a diesel engine. This allows the diesel engine, similar to the battery, to be controlled as the user enters the vehicle, thus reducing the time between the user entering the vehicle and the motor vehicle being available for driving.

For example, the motor vehicle function can be a safety function. For example, the safety function may be an operational safety function, such as releasing a brake or changing a gear. For example, the safety function may be an anti-theft function, such as a release of a steering wheel lock. Thus, in an advantageous exemplary embodiment, the driver can enter with the mobile terminal in the motor vehicle interior and thereby automatically causing the steering wheel lock to be released. Thus, the use of the motor vehicle is facilitated by the method. Further, this shortens the time required for the user to start the motor vehicle.

The motor vehicle function may be, for example, an autonomous driving function. The autonomous driving function may, for example, include autonomously driving to a destination and/or an autonomous parking function. In an advantageous exemplary embodiment, the user with the mobile terminal may enter into the motor vehicle and thereby cause an autonomous maneuvering function for leaving a parking lot to start. This controlled autonomous driving function may be dependent on the mobile terminal associated with a specific user. Thus, in one exemplary embodiment, an autonomous driving function of a high autonomy level, such as level 4 or 5, can also be effected by mobile terminals of users who are not capable of driving, such as elderly users. For example, this can also be effected by mobile terminals of users who are not capable of driving, such as children. The autonomous driving function is a particularly advantageous example of the motor vehicle function that can be controlled by the method. By verifying the position, it can be ensured that the motor vehicle does not drive off without the passenger with the mobile terminal due to an incorrect position detection.

The respective types of the respective motor vehicle functions, as mentioned above, can also be controlled in combination. For example, both the battery can be preheated and the motor vehicle interior can also be heated if the position in the motor vehicle interior is verified.

In one exemplary embodiment of the method, the first radio standard may, for example, be Bluetooth, Bluetooth Low Energy, Wireless LAN (WLAN) or Ultra Wide Band (UWB). For example, the Bluetooth radio standard comprises the Bluetooth Classic radio standard. In one exemplary embodiment, the first radio standard may use “Smart Ready” devices. Said standards may have a high range for position detection with low power consumption.

The second radio standard can be near field communication (NFC) or UWB. NFC can be implemented using RFID chips, for example. An RFID chip can, for example, be built into the mobile terminal or retrofitted into the mobile terminal. The RFID chip can, for example, be installed into an adapter that can be connected to the mobile terminal. This makes it possible to inexpensively expand existing mobile terminals that do not have the necessary RFID technology. Advantageously, respective mobile terminals can already use a built-in RFID chip. The second radio standards mentioned allow position detection with high accuracy, which makes them particularly suitable for verification. In addition, said second radio standards can also enable data transmission with high bandwidth and high eavesdropping security, thus enabling secure authentication in a simple manner. For example, a password can also be transmitted with the second radio standard, whereby the control of the motor vehicle function only takes place in case of the position being verified in the motor vehicle interior and correct password.

In one exemplary embodiment, the controlling of the motor vehicle function may be performed in response to the detected and/or verified position of the mobile terminal in the motor vehicle interior. For example, the controlling may occur if the verified position of the mobile terminal matches a predetermined position. The predetermined position may be predetermined, for example, by the manufacturer or by the user. Thereby, a plurality of predetermined positions may also be provided. For example, the predetermined position may be a corresponding storage surface, such as a dashboard surface, or a table surface, such as a folding table, which may be attached to the vehicle wall or to a seat. The predetermined position may correspond, for example, to a surface or receiving space of a center console or tray. The predetermined position may be defined by a receiving space or a fastening device, and in particular may be provided for the mobile terminal in the motor vehicle interior. The receiving space may be, for example, a glove compartment. The fastening device may, for example, fasten the mobile terminal to a portion of the motor vehicle interior in a way so that the mobile terminal remains attached to the fastening device while driving and/or while controlling the motor vehicle function. Advantageously, the predetermined position can specify to the user where the user must place his/her mobile terminal, so that the position of the mobile terminal is detected by radio according to the second, preferably short-range, radio standard. Preferably, only then the position in the motor vehicle interior can be verified. Thus, advantageously, a use by the user can be facilitated and accelerated.

In a further exemplary embodiment, the method may comprise a step of a subsequent position detection of the mobile terminal by radio according to the first and second radio standard. The subsequent or second position detection of the mobile terminal may occur temporally after the first position detection as already described above. Further, the method may comprise, for example, a step of verification of the subsequently detected position. A subsequently detected position may be, for example, a second detected position of the mobile terminal. Advantageously, the step of verification may be performed by comparing the second detected positions by radio according to the first and second radio standard. Advantageously, the verification described herein may be performed in the same way as the verification described above for the first position detection. Accordingly, there can then be a so-called first verified position and a so-called second verified position.

The method may advantageously comprise a step of terminating the motor vehicle function if the subsequent or second verified position of the mobile terminal does not correspond to the predetermined position. This may occur, for example, if the detected position of the mobile terminal no longer corresponds to the predetermined position, for example, due to removal from a storage tray by the user. In one embodiment, the step of terminating the motor vehicle function may depend on the position of the mobile terminal. Thus, the motor vehicle function may be terminated if the subsequently verified position is not in the motor vehicle interior. Thus, the user exiting the motor vehicle with his mobile terminal may only cause the termination of the motor vehicle function once exiting the motor vehicle.

The method can advantageously comprise a step of a third position detection of a further, for example second, mobile terminal. This third position detection can be performed, for example, by radio according to the first and second radio standard. The third position detection may, for example, occur temporally after the first and second position detection. For example, the third position detection may occur if the subsequently verified position of the first mobile terminal has caused the termination of the motor vehicle function. Further, the method may advantageously comprise a step of verification of the detected position of the second mobile terminal. The verification of the detected position of the second mobile terminal is advantageously performed by comparing the third position detections according to the first and second radio standards. The verification mentioned herein may be configured like the verification of the second detected position of the first mobile terminal and/or like the verification of the first position detection of the first mobile terminal. Advantageously, the method may further comprise a step of controlling a motor vehicle function, for example depending on the verified position of the second mobile terminal and/or if the verified position of the second mobile terminal is in the motor vehicle interior. Thereby the motor vehicle function may be identical to, or different from, the motor vehicle function described above. Thus, the controlling may be performed with the same or a different set of parameters. Advantageously, the controlling of the motor vehicle function may be performed if the verified position of the second mobile terminal matches the predetermined position. In one exemplary embodiment, the controlling may be performed if the verified position of the second mobile terminal is in the motor vehicle interior, and the verified or at least one detected position of the first mobile terminal is not in the motor vehicle interior.

The first user can leave the motor vehicle interior with his first mobile terminal. This can then, for example, automatically end the control of the motor vehicle function. In one exemplary embodiment, for example, the drive engine can then alternatively or additionally be switched off and/or the brake can be applied. The second user with his terminal device can thereupon enter the motor vehicle. Advantageously, this can enable the control of the motor vehicle function after verification of the detected position of the second mobile terminal. Thus, for example, a handover from one driver to the next driver can take place in compliance with all necessary safety standards. Thus, for example, a car sharing can be supported with the method. The vehicle can thereby be automatically secured as long as no driver is in the vehicle. The driver can actively control the motor vehicle during use, merely monitor an autonomous driving function or be a purely passive driver in the sense of a passenger.

In another embodiment, the method may comprise a step of engaging the mobile terminal in a holding device. This may, for example, result in engagement of the mobile terminal in the holding device. The holding device may, for example, be located in the predetermined position and/or be configured as a fastening device for the mobile terminal. The holding device may also be configured, for example, to be displaced relative to the motor vehicle by the user in the motor vehicle interior. Advantageously, the engagement of the mobile terminal may occur when the control of the motor vehicle function is started. Thereby, the engagement may occur without significant time delay after the control of the motor vehicle function is started. Advantageously, the mobile terminal is engaged in such a way that the mobile terminal is held non-releasably by the holding device. A non-releasable hold describes a hold of the mobile terminal in the holding device in which the mobile terminal cannot be removed from the holding device by a user without disproportionate force during intended use or without intentional manipulation. For example, the engaged mobile terminal can only be released from the holding device by damaging it.

Advantageously, the engagement of the mobile terminal in the holding device can be released when the motor vehicle function is terminated or while the motor vehicle function is being terminated. Disengaging the engagement allows the user to remove the mobile terminal from the holding device.

Advantageously, the engagement can prevent the mobile terminal from being removed from the predetermined position, in particular from the holding device. This can prevent unintentional termination of the motor vehicle function, which would be possible, for example, by removing the mobile terminal from the motor vehicle interior. This can be useful, for example, for safety-relevant motor vehicle functions, such as a lane-keeping function. Also, unintentional removal of the mobile terminal by another user who is not the owner of the mobile terminal can be prevented while the motor vehicle function is being performed. For example, this may be advantageous for driving service providers with passengers, since theft of the driving service provider's mobile terminal device by passengers may be prevented during execution of the motor vehicle function, such as during the operating time of the drive engine function.

In a further embodiment, the method may preferably comprise charging the mobile terminal at the predetermined position. The charging of the mobile terminal may include charging the energy storage, such as a battery, of the mobile terminal. The charging may be performed by means of electrical contacts, such as a plug or a socket. Alternatively, charging may be contactless, such as by induction. For charging, the motor vehicle may comprise a charger, for example integrated at the predetermined position and/or in the holding device. An advantage of charging is an extended use duration life of the mobile terminal, in particular also an extended use duration for effecting control of a motor vehicle function.

The method may advantageously comprise a step of generating a status signal of the mobile terminal. The status signal may, for example, be a status of the energy storage device, a status of a navigation application, or a telephony status. For example, the status of a navigation application may comprise a route proposal. The telephony status may indicate, for example, whether the user is currently making a call via the mobile terminal. The status signal may, for example, be detected and/or emitted by the mobile terminal. For example, the status signal may be transmitted from the mobile terminal to the motor vehicle by means of a communication device of the mobile terminal and the motor vehicle. For example, the status signal may be transmitted by radio according to the first and/or second radio standard. Preferably, the status signal is a radio signal used by the position detection method, wherein the status signal is generated by the mobile terminal, for example. The radio signal for position detection can therefore also transmit status information, for example. The motor vehicle may, for example, detect the status signal by means of a sensor device. The motor vehicle function can preferably be controlled depending on the status signal, for example depending on the value of the status signal. For example, the sensor device may detect by means of the status signal that the telephone is currently being used to make a telephone call. The sensor device may be configured to detect the signal sent by the mobile terminal for making phone calls via the mobile network as a status signal.

In one embodiment, the motor vehicle function may be to switch on the drive engine. If a user is making a phone call with the mobile terminal while entering the motor vehicle, the status signal is used to indicate that the user is currently on the phone and is not allowed to drive off with the motor vehicle. For example, switching on the engine can be prevented by the method. In this way, vehicle control by a distracted driver can be avoided.

In a further embodiment, the method may comprise detecting a temperature. The temperature may be, for example, a motor vehicle interior temperature, an engine temperature, a battery temperature and/or an ambient temperature. The temperature may be detected by a sensor device. For example, the motor vehicle and/or the mobile terminal may comprise this sensor device.

Preferably, control of the motor vehicle function, in particular control of a heating function, can be performed depending on the detected temperature. Thus, in one embodiment, the motor vehicle interior can be heated depending on the ambient temperature and/or the motor vehicle interior temperature. Optionally, the heating function may additionally be performed depending on the mobile terminal associated with a particular user. Thus, the method can control the heating function of the motor vehicle interior with a first target temperature, which can be taken from a first parameter set, when a first user with a first mobile terminal assigned to him, enters the motor vehicle. A second user with a second mobile terminal assigned to him can cause the heating function of the motor vehicle interior to be controlled with a second target temperature, which can be taken from a second parameter set, when the second user enters the motor vehicle with a second mobile terminal assigned to him. The first and second target temperatures can be different. Thus, advantageously, a user-specific temperature of the motor vehicle interior can be controlled.

In a further embodiment, a driving function can be controlled depending on the ambient temperature. For ambient temperatures around the freezing point, different friction conditions between the road surface and the tires must be expected than at higher temperatures. Thus, in one embodiment, the traction of the drive wheels can be controlled as a motor vehicle function depending on the ambient temperature. In this way, for example, driving safety can be increased.

In a further embodiment, the method may comprise a step of detecting a motor vehicle state, in particular a seat occupation state. A seat occupation state may indicate, for example, whether a particular seat is occupied, which means whether a user or another person, if applicable, is seated on the seat. A motor vehicle state may also be, for example, a door opening state or a tilt state of the motor vehicle relative to the horizontal.

The motor vehicle function can preferably be controlled depending on the motor vehicle state. In particular, the motor vehicle function can be a safety function, such as controlling the brake.

In an advantageous exemplary embodiment, the seat occupation state of the motor vehicle can be detected. For example, the user may be in the motor vehicle interior with the mobile terminal. The motor vehicle function may, for example, be a release of the brake. The release of the brake may be dependent on the seat occupation state. That means, if the user is on a seat other than the driver's seat of the motor vehicle, the control, in this case the release of the brake, is not effected by a mobile terminal located in the motor vehicle interior. This further improves the safety when using the motor vehicle.

In a further exemplary embodiment, the method may, for example, comprise a step of optical detection. Preferably, an area of the motor vehicle interior is detected. An area of the motor vehicle interior may be the entire motor vehicle interior or only a partial area thereof. For example, a partial area may be an area of the seats, preferably the driver's seat. A sensor device can be provided for optical detection, preferably a camera in the motor vehicle interior.

Preferably, the method may comprise a step of comparing the detected partial area including facial information of users. The facial information is preferably stored in a database of a database device. Users here are a set of potential users of the motor vehicle registered in the database of the database device. A set of potential users registered in a database with their facial information may, for example, be users of pool vehicles. The database device may, for example, be provided external to the motor vehicle and communicate with the motor vehicle via a communication device. However, the database device may also be part of the motor vehicle and/or the mobile terminal. The matching of the detected partial area including facial information may, for example, comprise a comparison of identifying features of a face with stored identifying features of users. An image recognition algorithm may be used for this purpose. The method may preferably comprise a step of authentication of the user. This authentication is preferably based on the matching of facial information described above. The authentication may be, for example, a verification of an indication of the user regarding his identity. For this purpose, a user may, for example, indicate by means of his mobile terminal that he possess a certain identity. By optical detection of a partial area of the motor vehicle interior, in which the user is located, a comparison can thus be made and thus preferably, if the user's indication of his identity is successfully verified, the user can be authenticated. Thus, for example, authentication of the user may be performed. The method may further preferably comprise a step of controlling the motor vehicle function depending on the authentication of the user. By means of the previously described authentication, for example, control of a motor vehicle function by an unauthenticated user may be prevented. For example, a user with a mobile terminal not assigned to him can thus not assert a false identity and use the motor vehicle function without authorization. Thus, for example, switching on the drive engine of the motor vehicle function can be prevented. Theft of the motor vehicle by an unauthenticated user with a stolen mobile terminal can thus be prevented.

In another embodiment, the method may comprise a step of authentication of payment information. The authentication can preferably be performed by radio according to the second radio standard, such as by means of NFC or UWB. During the authentication, a user can, for example, specify and/or transmit payment information by means of his mobile terminal. This can then be compared, for example, with payment information stored for the user in a database device. If the payment information is successfully verified, the transmitted payment information of the user can be authenticated and the motor vehicle function can be enabled and controlled, provided that the verified position of the mobile terminal is in the motor vehicle interior.

Preferably, control of the motor vehicle function may depend on the authentication of the payment information. A motor vehicle function may be, for example, switching on the drive engine and/or starting an autonomous driving function.

In one embodiment, a user can specify payment information via his mobile terminal using NFC. The vehicle can then compare this payment information with payment information already stored in a database for this user. If the matching is successful, the payment information is authenticated. After successful authentication of the payment information, the engine can advantageously be switched on. Thus, for example, a car sharing concept can be operated that does not allow driving without validly stored payment information.

Another aspect of the invention relates to a control system for controlling at least one motor vehicle function. The motor vehicle function may be, for example, one of the motor vehicle functions as described in connection with the first aspect. The controlling of the motor vehicle function may, for example, be performed depending on the parameters described above. The control system is preferably configured to perform the method according to the first aspect.

The control system comprises at least a first detection device. The first detection device is configured to detect the position of a mobile terminal, such as a mobile terminal described above. The first position detection device is configured to determine the position by radio according to a first radio standard, preferably according to one of the first radio standards described above. The first detection device preferably comprises a control device and a plurality of antennas configured to detect the position of the mobile terminal. These antennas may preferably be distributed in respective room corners of the motor vehicle interior to enable the most accurate position detection as possible.

The control system comprises a second detection device, which is configured to detect the position of the mobile terminal by radio according to a second radio standard. The second radio standard is preferably identical to one of the second radio standards described above. Preferably, the second detection device is configured to authenticate payment information. Preferably, the second detection device comprises a control device and an antenna.

Further, the control system preferably comprises a verification device configured to verify the detected position of the mobile terminal. For example, the verification device may also be provided by the first and/or the second detection device.

The control system preferably comprises a control device. The control device is configured to control the motor vehicle function, in particular depending on the verified position. The controlling may be, for example, a controlling according to the first aspect. The first and second detection device, the verification device and the control device are preferably connected to each other and/or configured as part of the motor vehicle. The verification device and the control device may be formed by a common device, such as an on-board computer. A connection can be provided directly or indirectly through another device. The connection may be wired or wireless. Preferably, the connection is established by means of a radio signal according to the first and/or second radio standard, whereby corresponding antennas for position detection can also be used for the connection. The wireless connection can be provided via WLAN, for example.

In one embodiment of the invention, the control system may comprise a receiving device. The receiving device may preferably be configured to receive a status signal from the mobile terminal. The receiving device may be formed, for example, by the first and/or second detection device. The receiving device may, for example, be formed by a separate receiving device, such as a WLAN router or an NFC antenna.

The control system can preferably comprise a sensor device. The sensor device can preferably be configured to detect a temperature, a motor vehicle state and/or a partial area of the motor vehicle interior. For example, the sensor device may comprise a camera, an antenna, a piezo sensor, and/or a temperature sensor.

Advantageously, the control system may comprise a charging device that is configured to charge the mobile terminal. The charging device may be configured to charge the mobile terminal by means of electrical contacts and/or induction.

Advantageously, the control system may comprise a database device. For example, the database device may be configured as part of the motor vehicle and/or the mobile terminal. For example, the database device may also be configured as a separate device, such as a central server. Then, the database device can be protected better from unauthorized access by users and from destruction. For example, a database device may be a NAS. Preferably, the database device is configured to store facial information of users.

Advantageously, the control system may comprise a mobile terminal, such as a mobile key element or a cell phone, or other mobile terminals described above. Preferably, the control system may comprise a plurality of mobile terminals, wherein the terminals may be associated with respective users.

For example, the receiving device, the sensor device, the charging device, the database device and/or the mobile terminal may be connected to the first and second detection device, the verification device and the control device. The connection may be wired or wireless. A wireless connection may be provided via WLAN, for example.

### BRIEF DESCRIPTION OF THE FIGURES

FIG. 1 illustrates, in a schematic view, a method for controlling a motor vehicle function.

FIG. 2 illustrates, in a schematic view, a control system for controlling a motor vehicle function with the method according to FIG. 1.

### DETAILED DESCRIPTION OF EMBODIMENTS

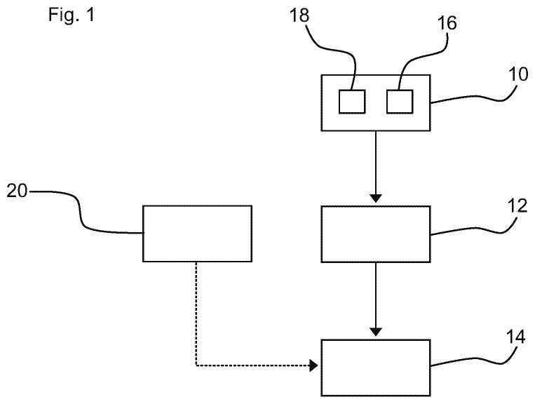

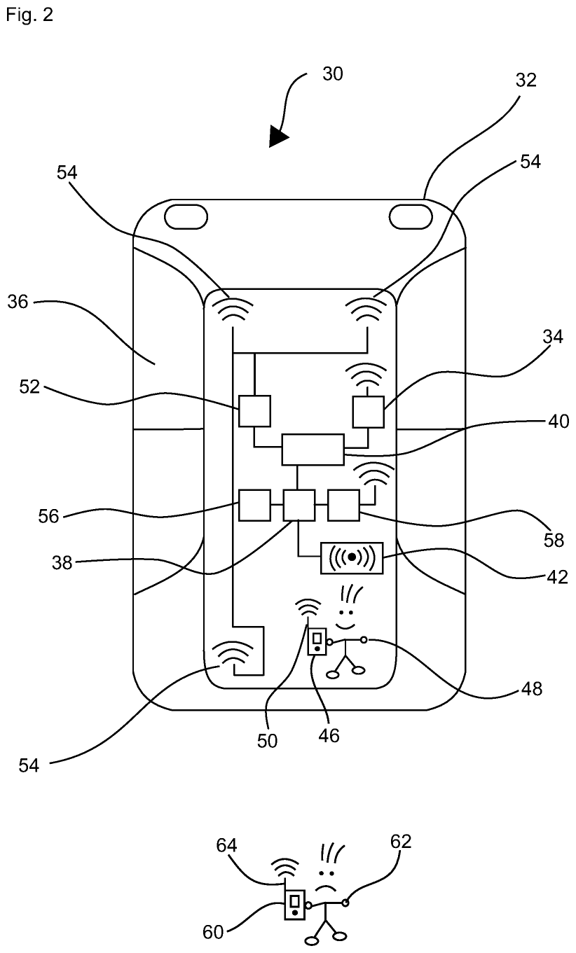

FIG. 1 shows, in a schematic view, a method for controlling a motor vehicle function. The method comprises step 10 of detecting the position of a first mobile terminal, such as the first mobile terminal 46 of a first user 48 in FIG. 2. Therein, the position of the mobile terminal 46 is detected by means of a first and a second radio signal, wherein radio signals may be received and/or generated by means of an antenna 50 of the mobile terminal 46. In one embodiment, the position detection is performed by means of triangulation. The detection of the position of the mobile terminal by means of the first and second radio signals represent position detections 16, 18 by radio according to the first and second radio standards. In one embodiment, the first radio standard is Bluetooth, UWB or WLAN. In one embodiment, the second radio standard is UWB or NFC.

In one embodiment, the position of a second mobile terminal 60 of a second user 62 is also detected. The step of position detection 10 of the position of the second mobile terminal 60 of the second user 62 is performed by position detections 16, 18 by radio according to the first and second radio standards, as described above. In one embodiment, the position detection of the mobile terminals 46, 60 is performed simultaneously or with a temporal offset.

After the position detection, the method comprises a verification step 12. The verification comprises a comparison of the positions of the first mobile terminal 46 detected by the position detections 16, 18, which were previously detected by radio according to the first and second radio standards. If the detected positions match, the verification step 12 results in a verified position of the first mobile terminal 46, for example, in a motor vehicle interior. In one embodiment, a maximum distance between the detected position by radio according to the first radio standard and the detected position by radio according to the second radio standard is predetermined, within which the position of the mobile terminal is verified. In this way, a measurement inaccuracy of the position detections 16, 18 can be taken into account. In one embodiment, the verification 12 of the detected position for the second mobile terminal 60 is performed analogously to the verification 12 of the detected position of the first mobile terminal 46. In one embodiment, the verification 12 of detected positions from the two mobile terminals 46, 60 is performed simultaneously or with a temporal offset.

Depending on the verified position, at least one motor vehicle function is controlled in step 14. In particular, if a verified position of the mobile terminal 46 is in the motor vehicle interior, the motor vehicle function can be started as a control, for example with a user-specific parameter.

In one embodiment, the step 14 of controlling the motor vehicle function is additionally performed depending on a state detection 20. The state detection may be a temperature detection by means of a thermometer, a detection of a state signal of respective mobile terminals 46, 60 by means of a sensor device 56, an image capturing by means of a camera, or a pressure detection by means of a piezo element. Thus, for example, a parameter for the control of the motor vehicle function can be set depending on the detected status if the verified position of the first mobile terminal 46 is in the motor vehicle interior.

FIG. 2 shows a schematic view of a control system 30 for controlling the motor vehicle function of a motor vehicle 32. The motor vehicle 32 comprises a first detection device 52 comprising three antennas 54. The antennas 54 are spaced apart from each other in the motor vehicle 32 to enable position detection according to step 10 using triangulation. Preferably, the antennas 54 are located in corners of the motor vehicle 32 to increase the accuracy of the position detection 16 performed by triangulation. The antennas 54 may be oriented in different directions, meaning that the main direction of extension of each antenna 54 may point substantially in one of the three spatial direction axes. This can ensure that the position detection 16 can be performed by means of the antennas 54 of the first detection device 52 in the entire interior of the motor vehicle. The motor vehicle 32 further comprises a second detection device 34, which comprises, for example, only one antenna. In one embodiment, the second detection device 34 is configured as an RFID reader and is integrated in a holding device for the respective mobile terminals 46, 60. The first and second detection devices 52, 34 are connected to the verification device 40. Each one of the two detection devices 52, 34 transmits its respective detected position to the verification device 40. Alternatively or additionally, the verification device 40 may request the detected positions from the detection devices 52, 34. The verification device 40 is configured for verification 12 of the detected positions of the mobile terminal 46, 60. In one embodiment, the verification device 40 is configured to compare the detected positions detected by the detection devices 52, 34 and to verify the detected position of the respective mobile terminals 46, 60 if the two detected positions match, possibly within a predefined tolerance range. The verification device 40 is connected to a control device 38. The verification device 40 transmits at least information about the verified position to the control device 38. Alternatively or additionally, the control device 38 may request information about the verified position and/or the verified position from the verification device 40. The control device 38 is configured to control the motor vehicle function 14 if the verified position results in a position of a respective mobile terminal 46, 60 on the RFID reader. In addition, a sensor device 56 is configured to detect status information and is connected to the control device 38. In one embodiment, the state information is a seat occupation state. In one embodiment, the sensor device 56 alternatively or additionally comprises a pressure sensor. The sensor device 56 may be configured to transmit the status information to the control device 38. The control device 38 may be connected to a receiving device 58, which may be configured to retrieve data from a database device, for example for facial recognition, and/or to receive and authenticate payment information. In one embodiment, the receiving device 58 is a WLAN router. The receiving device 58 may be configured to receive data from the control device 38 and/or transmit data to the control device 38. The control device 38 is connected to a charging device 42. In one embodiment, the charging device 42 is an inductive charging device. In one embodiment, the charging device 42 is configured as part of a holding or fastening device for respective mobile terminals 46, 60, wherein the holding device may also comprise the second detection device 34 and may specify a position for storing the respective mobile terminal 46, 60 in the motor vehicle. In one embodiment, the motor vehicle 32 comprises a motor vehicle door 36 through which respective users 48, 62 may enter and/or exit the motor vehicle interior.

Here, for example, the first mobile terminal 46 with the first user 48 is located in the motor vehicle interior. Accordingly, after successful verification 12 of the detected position of the mobile terminal 46, the motor vehicle function is controlled depending on the verified position of the first mobile terminal 46. For the second mobile terminal 60 of the second user 62, no position within the motor vehicle interior is verified via an antenna 64, so that the motor vehicle function cannot be controlled depending on its position. In another embodiment, the detected position of the second mobile terminal 60 of the second user 62 is verified outside the motor vehicle interior. This may occur if the second detection device 34 is positioned close to the edge of the motor vehicle interior. If the detected position of the second mobile terminal is verified outside the interior of the motor vehicle, the motor vehicle function is controlled at least not based on the position verified in the exterior space.

1. A method of controlling at least one motor vehicle function of a motor vehicle, wherein the method comprises at least the following steps:
detecting a position of a mobile terminal, such as a cell phone or a key, by radio according to a first and second radio standard, wherein the first and second radio standard are different;
verifying the detected position of the mobile terminal by comparing the detected position according to the first radio standard with the detected position according to the second radio standard; and
if the verified and detected position of the mobile terminal is inside a motor vehicle interior, controlling the at least one motor vehicle function.

2. The method according to claim 1, wherein the mobile terminal comprises at least one of a cell phone or a key.

3. The method according to claim 1, wherein the at least one motor vehicle function comprises at least one of the following functions:
a motor function;
a heating function;
a safety function; or
an autonomous driving function.

4. The method according to claim 3, wherein the motor function comprises at least one of switching a drive engine on or switching the drive engine off.

5. The method according to claim 3, wherein the heating function comprises at least one of heating a motor vehicle interior, a battery, or a drive engine.

6. The method according to claim 3, wherein the safety function comprises at least one of releasing a steering wheel lock, releasing a brake, or changing a gear.

7. The method according to claim 1, wherein the first radio standard comprises Bluetooth, Bluetooth Low Energy, a wireless local area network (WLAN) or ultra-wide band (UWB) and the second radio standard comprises near-field communication (NFC) or UWB.

8. The method according to claim 1, wherein the control of the motor vehicle function is performed if the detected position of the mobile terminal matches with a predetermined position.

9. The method according to claim 8, wherein the method further comprises the steps of:
detecting a subsequent position of the mobile terminal by radio according to the first and second radio standard;
verifying the detected subsequent position of the mobile terminal by comparing the detected subsequent position according to the first radio standard with the detected subsequent position according to the second radio standard;
if the verified detected subsequent position no longer corresponds to the predetermined position, terminating the motor vehicle function;
detecting a position of a second mobile terminal by radio according to the first and second radio standard;
verifying the detected position of the second mobile terminal by comparing the detected position according to the first radio standard with the detected position according to the second radio standard; and
if the verified position of the second mobile matches the predetermined position, controlling the at least one motor vehicle function.

10. The method according to claim 8, wherein the method further comprises the steps of:
engaging the mobile terminal in a holding device in the predetermined position when the control of the motor vehicle function is started, wherein the mobile terminal is non-releasably held by the holding device; and
disengaging the mobile terminal from the holding device when the motor vehicle function is terminated.

11. The method according to claim 10, wherein the method further comprises the step of charging the mobile terminal at the predetermined position.

12. The method according to claim 1, wherein the method further comprises the steps of:
generating a status signal of the mobile terminal, wherein the status signal indicates in particular whether a telephone call is being made with the mobile terminal; and
controlling the at least one motor vehicle function depending on the status signal from the mobile terminal.

13. The method according to claim 3, wherein the method further comprises the steps of:
detecting a temperature, wherein the detected temperature comprises at least one of a motor vehicle interior temperature, an engine temperature, a battery temperature, or an ambient temperature; and
controlling the heating function depending on the detected temperature.

14. The method according to claim 3, wherein the method further comprises the steps of:
detecting a motor vehicle state, wherein the detected motor vehicle state comprises a seat occupation state; and
controlling the safety function depending on the motor vehicle state.

15. The method according to claim 1, wherein the method further comprises the steps of:
optically detecting at least a partial area of the motor vehicle interior;
comparing the detected partial area with user facial information from a database device;
authenticating the user based on the comparison; and
controlling the at least one motor vehicle function depending on the authentication of the user.

16. The method according to claim 1, wherein the method further comprises the steps of:
authenticating payment information by radio according to the second radio standard; and
controlling the at least one motor vehicle function depending on the authentication of the payment information.

17. A control system for controlling at least one motor vehicle function, wherein the control system comprises at least:
a first detection device configured to detect the position of a mobile terminal by radio according to a first radio standard;
a second detection device configured to detect the position of the mobile terminal by radio according to a second radio standard;
a verification device configured to verify the detected position of the mobile terminal; and
a control device configured to control a motor vehicle function depending on the verified position of the mobile terminal.

18. The control system according to claim 17, wherein the control system further comprises at least one of:
a receiving device configured to receive a status signal from the mobile terminal;
a sensor device configured to detect at least one of a temperature, a motor vehicle state, or a partial area of the motor vehicle interior;
a charging device configured to charge the mobile terminal;
a database device; or
a mobile device.
